(19) United States
(12) Patent Application Publication
(10) Pub. No.: US 2008/0117983 A1
(43) Pub. Date: May 22, 2008

(54) Method And Device For Densifying A Motion Field

(75) Inventors: Stephane Pateux, Saint-Gregoire (FR); Sylvain Kervadec, Rennes (FR); Isabelle Amonou, Thorigne Fouillard (FR)

Correspondence Address: LOWE HAUPTMAN HAM & BERNER, LLP, 1700 DIAGONAL ROAD, SUITE 300, ALEXANDRIA, VA, 22314, US

(73) Assignee: FRANCE TELECOM, Paris, (FR)

(21) Appl. No.: 11/571,964

(22) PCT Filed: Jun. 28, 2006
(86) PCT No.: PCT/FR05/01626

§ 371 Date: Jun. 22, 2007

(30) Foreign Application Priority Data
Jul. 13, 2004 (FR) 0407835

(51) Int. Cl. H04N 7/12

(52) U.S. Cl. 375/240.26; 375/E07.092

(57) ABSTRACT

A motion field between a destination image and a source image is densified on the basis of the motion field between the source image and the destination image. Connections between the source image pixels or subpixels (X11, X111, X12, X121) and the destination image pixels or subpixels (B, C′, E, F) are determined. For each pixel or subpixel of the destination image connected to a pixel or subpixel of the source image, a pixel or subpixel association space (Fen) including one pixel or subpixel of the destination image is determined. Each pixel or subpixel in the association space (A, A′, B, B′, C, C′) is associated with the source image pixel (X11) connected to the pixel or subpixel to form a dense motion field between the destination and source images.

### RELATED APPLICATIONS

The present application is based on, and claims priority from, France Application Number 04 07835, filed Jul. 13, 2004, and PCT/FR05/01626, filed Jun. 28, 2005, the disclosures of which are hereby incorporated by reference herein in their entirety.

### FIELD OF THE INVENTION

The present invention relates to a method and a device for densifying a motion field between a source image and a destination image.

More specifically, the present invention relates to the field of image processing in which points of a destination image have to be associated with points of a source image.

### BACKGROUND OF THE INVENTION

Certain algorithms in the field of encoding a digital image sequence propose solutions for associating points between two images.

These algorithms make use of motion-compensated temporal filtering by means of discrete wavelet decomposition. These algorithms firstly perform a wavelet temporal transformation between the images of the video image sequence and then spatially decompose the resulting temporal subbands. More specifically, the video image sequence is decomposed into two groups of images, the even images and the odd images, and a motion field is estimated between each even image and the closest odd image or images used during the wavelet temporal transformation. The even and odd images are motion-compensated with respect to one another in an iterative manner so as to obtain temporal subbands. The iteration of this group creation and motion compensation process can be carried out in order to generate different levels of wavelet transformation. The temporal images are subsequently filtered spatially by means of wavelet analysis filters.

At the end of the decomposition, the result is a set of spatiotemporal subbands. The motion field and the spatiotemporal subbands are finally encoded and transmitted in layers corresponding to the resolution levels targeted. Some of these algorithms carry out temporal filtering according to the technique presented in the publication by W. Sweldens, Siam J. Anal., Vol. 29, No. 2, pages 511-546, 1997 and known as “lifting”.

Among these algorithms, it has been proposed in the publication entitled “3D subband video coding using Barbell Lifting; MSRA Asia; Contribution S05 to the CFP MPEG-21 SVC” to match the pixels of the even images to pixels of the odd images so as to update the pixels of the even images by reusing weightings of the pixels of the odd images used during the prediction of the odd images on the basis of the even images, so as to carry out weighted updating using these weightings. A point P(x,y) of an even image contributing with a weight w to the prediction of a point Q′(x′,y′) of an odd image will be updated with a contribution of the weighted point Q′(x′,y′) of the weight w.

This solution is not satisfactory. This is because several problems are not solved by this algorithm. Tn the even images, there are pixels which are not matched. This lack of matching of pixels, referred to as holes, means that the updating of the motion field is not perfectly reversible and causes artefacts when the image is reconstructed at the client's decoder. In addition, for certain pixels updated by a plurality of pixels of an even image, the updating is not normalized. This lack of normalization also causes artefacts, such as pre-echoes and/or post-echoes, when the image is reconstructed at the client's decoder. Finally, when the objects contained in the images of the video image sequence are subjected to movements such as flips, the process of matching pixels as proposed in this publication is not optimal.

Patent application WO 030859990 describes a method which makes it possible to accelerate the calculation of backward motion vectors in a sequence of video images derived from an available motion field on the basis of forward displacement vectors. In said application, motion vectors of one block are replaced by the motion vectors of adjacent blocks. Although this method is suitable for movements between images such as zoom movements, it is not suitable for processing flips movements.

The object of the invention is to overcome the disadvantages of the prior art by proposing a method and a device which make it possible to densify a motion field between a source image and a destination image, said method and device being particularly suited to the processing of flips movements as may occur for example in areas of occultation.

### SUMMARY OF THE INVENTION

To this end, according to a first aspect, the invention proposes a method for densifying a motion field between a destination image and a source image from a motion field between the source image and the destination image, characterised in that the method comprises the following steps:
determining connections between the pixels or subpixels of the source image and the pixels or subpixels of the destination image,
determining, for each pixel or subpixel of the destination image connected to a pixel or subpixel of the source image, a pixel or subpixel association space comprising at least one pixel and/or subpixel of the destination image,
associating each pixel or subpixel contained in the association space with the pixel or subpixel of the source image connected to said pixel or subpixel so as to form a dense motion field between the destination image and the source image.

Correlatively, the invention relates to a device for densifying a motion field between a destination image and a source image from a motion field between the source image and the destination image, characterised in that the device comprises:
means for determining connections between the pixels or subpixels of the source image and the pixels or subpixels of the destination image,
means for determining, for each pixel or subpixel of the destination image connected to a pixel or subpixel of the source image, a pixel or subpixel association space comprising at least one pixel and/or subpixel of the destination image,
means for associating each pixel or subpixel contained in the association space with the pixel or subpixel of the source image connected to said pixel or subpixel so as to form a dense motion field between the destination image and the source image.

Thus, all the pixels or subpixels of the destination image are associated with a pixel or subpixel of the source image, and the motion field is thus perfectly reversible and does not cause any artefacts when the image is reconstructed at the client's decoder. Moreover, the densification of the motion field between a destination image and a source image is particularly suitable when the objects contained in the images of the video image sequence are subjected to movements such as flips movements in areas of occultation.

According to another aspect of the invention, the association space is determined by determining a working space in the destination image as a function of the pixels or subpixels connected to the pixels or subpixels adjacent to the pixel or subpixel of the source image connected to the pixel or subpixel with which the working space is associated, and by determining the association space in the determined working space, on the basis of the pixel or subpixel with which the working space is associated and on the basis of the pixels or subpixels connected to the pixels or subpixels adjacent to the pixel of the source image connected to the pixel or subpixel with which the working space is associated.

It is thus possible to define rapidly and effectively the pixels or subpixels of the destination image which are not connected next to the pixel or subpixel which is connected.

According to another aspect of the invention, the association space is determined by determining, among the pixel or subpixel with which the working space is associated and the pixels or subpixels connected to the pixels or subpixels adjacent to the pixel or subpixel of the source image connected to the pixel or subpixel with which the working space is associated, the pixels or subpixels delimiting the working space as a function of their coordinates in the destination image, and by determining the association space on the basis of the coordinates of the pixel or subpixel with which the working space is associated and the distances separating the pixel or subpixel with which the working space is associated from the pixels or subpixels delimiting the working space.

Thus, the densification of the motion field is carried out rapidly while allowing good-quality densification of the motion field for the encoding and/or decoding of the video image sequence.

According to another aspect of the invention, the distances separating the pixel or subpixel with which the working space is associated from the pixels or subpixels delimiting the working space are weighted by a coefficient of the order of one half.

It is thus possible to control the rate of densification and/or the rate of overlapping of the association spaces and thus to reduce the blurring phenomena during the decoding of the video image sequence. The value of the coefficient of one half makes it possible to obtain the best compromise between complete densification of the motion field and minimum overlap of the association spaces.

The invention also relates to a device for motion-compensated temporal filtering of a video image sequence encoder, characterised in that it comprises the device for densifying a motion field according to the present invention.

The invention also relates to a device for motion-compensated inverse temporal filtering of a video image sequence decoder, characterised in that it comprises the device for densifying a motion field according to the present invention.

The invention also relates to a signal comprising a video image sequence encoded by motion-compensated temporal filtering by means of discrete wavelet decomposition, the signal comprising high-frequency images and low-frequency images, the low-frequency images being obtained by densifying the motion field between a source image from a group of source images and a destination image from a group of destination images on the basis of a motion field between the destination image and the source image, and in which the densification is performed by determining connections between the pixels or subpixels of the source image and the pixels or subpixels of the destination image, by determining, for each pixel or subpixel of the destination image connected to a pixel or subpixel of the source image, a pixel or subpixel association space comprising at least one pixel and/or subpixel of the destination image, and by associating with each pixel or subpixel contained in the association space the pixel or subpixel of the source image connected to said pixel or subpixel so as to form a dense motion field between the destination image and the source image.

The invention also relates to a method of transmitting a signal comprising a video image sequence encoded by motion-compensated temporal filtering by means of discrete wavelet decomposition, the signal comprising high-frequency images and low-frequency images, the low-frequency images being obtained by densifying the motion field between a source image from a group of source images and a destination image from a group of destination images on the basis of a motion field between the destination image and the source image, and in which the densification is performed by determining connections between the pixels or subpixels of the source image and the pixels or subpixels of the destination image, by determining, for each pixel or subpixel of the destination image connected to a pixel or subpixel of the source image, a pixel or subpixel association space comprising at least one pixel and/or subpixel of the destination image, and by associating with each pixel or subpixel contained in the association space the pixel or subpixel of the source image connected to said pixel or subpixel so as to form a dense motion field between the destination image and the source image.

The invention also relates to a method of storing a signal comprising a video image sequence encoded by motion-compensated temporal filtering by means of discrete wavelet decomposition, the signal comprising high-frequency images and low-frequency images, the low-frequency images being obtained by densifying the motion field between a source image from a group of source images and a destination image from a group of destination images on the basis of a motion field between the destination image and the source image, and in which the densification is performed by determining connections between the pixels or subpixels of the source image and the pixels or subpixels of the destination image, by determining, for each pixel or subpixel of the destination image connected to a pixel or subpixel of the source image, a pixel or subpixel association space comprising at least one pixel and/or subpixel of the destination image, and by associating with each pixel or subpixel contained in the association space the pixel or subpixel of the source image connected to said pixel or subpixel so as to form a dense motion field between the destination image and the source image.

The advantages of the encoding method, the decoding method, the encoding device, the decoding device and the signal comprising the video image sequence transmitted or stored on a storage means are identical to the advantages of the method and device for densifying the motion field. They will not be repeated.

The invention also relates to the computer program stored on an information medium, said program comprising instructions which make it possible to implement the method described above when it is loaded and run by a computer system.

The abovementioned features of the invention, as well as others, will become more clearly apparent from reading the following description of an example of embodiment, said description being given with reference to the appended drawings.

### BRIEF DESCRIPTION OF THE DRAWING

FIG. 1 is a block diagram of a motion-compensated temporal filtering video encoder using the matching method according to a preferred embodiment of the invention;

FIG. 2 is a block diagram of the motion-compensated temporal filtering module of the video encoder of FIG. 1 using the matching method according to the invention when Haar filters are used in the wavelet decomposition;

FIG. 3 is a block diagram of a computer and/or telecommunication device which is able to execute the matching algorithm according to a preferred embodiment of the invention;

FIG. 4 is a diagram of the matching algorithm according to a preferred embodiment of the invention executed by a processor of a computer and/or telecommunication device;

FIG. 5 is a diagram of a simplified example of matching pixels and subpixels of a destination segment with pixels or subpixels of a source segment;

FIG. 6 is a diagram of a simplified example of matching other pixels and subpixels of the destination segment of FIG. 5 with pixels or subpixels of the source segment;

FIG. 7 is a diagram of an example of matching pixels and subpixels of a destination image with pixels or subpixels of a source image;

FIG. 8 is a block diagram of a motion-compensated temporal filtering video decoder using the matching method according to a preferred embodiment of the invention;

FIG. 9 is a block diagram of the motion-compensated inverse temporal filtering module of a video decoder of FIG. 8 using the matching method according to a preferred embodiment of the invention when Haar filters are used in the wavelet decomposition.

### DETAILED DESCRIPTION OF THE DRAWING

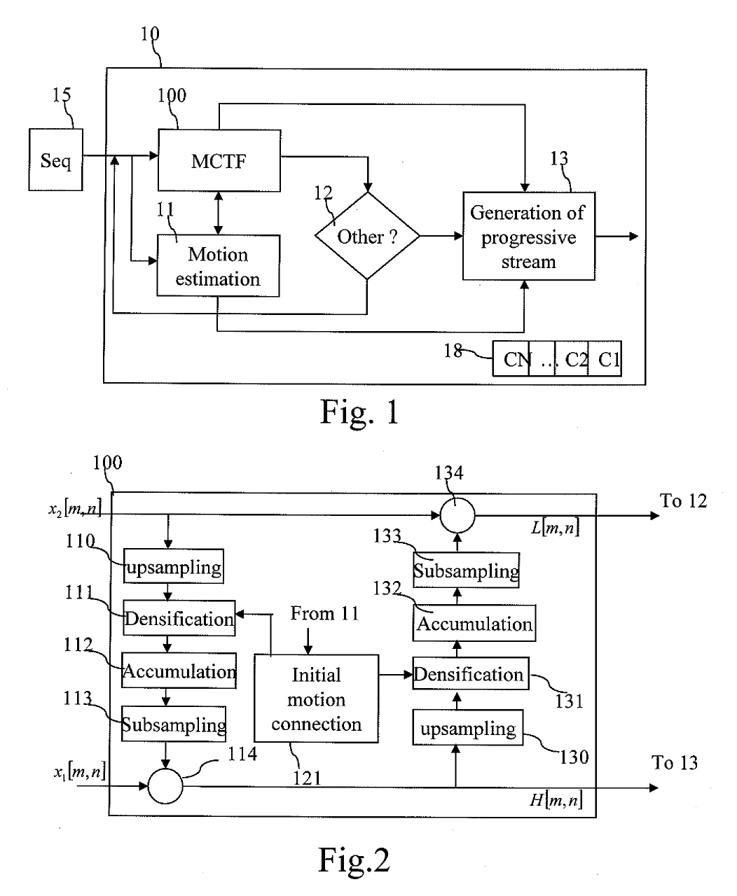

FIG. 1 shows a block diagram of a motion-compensated temporal filtering video encoder using the matching method according to the invention.

The motion-compensated temporal filtering video encoder 10 is able to encode a video image sequence 15 into a scalable data stream 18. A scalable data stream is a stream in which the data are arranged in such a way that it is possible to transmit a representation, in terms of resolution and/or quality of the image, which varies according to the type of application receiving the data. The data contained in this scalable data stream are encoded so as to ensure the transmission of video image sequences in a scaled or “scalable” manner in terms of both quality and resolution, without having to carry out different encodings of the video image sequence. It is thus possible to store on a storage means and/or to transmit only part of the scalable data stream 18 to a telecommunication terminal when the transmission rate of the telecommunication network is low and/or when the telecommunication terminal does not require a high quality and/or resolution. It is also possible to store on a storage means and/or to transmit the entire scalable data stream 18 to a telecommunication terminal when the transmission rate of the telecommunication network is high and when the telecommunication terminal requires a high quality and/or resolution, on the basis of the same scalable data stream 18.

The motion-compensated temporal filtering video encoder 10 comprises a motion-compensated temporal filtering module 100. The motion-compensated temporal filtering module 100 converts a group of N images into two groups of images, for example a group of (N+1)/2 low-frequency images and a group of N/2 high-frequency images, and converts these images on the basis of a motion estimation made by a motion estimation module 11 of the motion-compensated temporal filtering video encoder 10. The motion estimation module 11 performs a motion estimation between each even image denoted x₂[m,n] and the preceding odd image denoted x₁[m,n], or optionally the odd image of the following pair, in the image sequence. The motion-compensated temporal filtering module 100 performs motion compensation for the even image x₂[m,n] so that the temporal filtering is as effective as possible. This is because the smaller the difference between a prediction of an image and the image, the more it will be able to be compressed effectively, that is to say with a good compromise in terms of rate/distortion or, in an equivalent manner, a good ratio of compression ratio to reconstruction quality.

The motion estimation module 11 calculates a motion field for each pair of even and odd images, for example and in a non-limiting manner by matching blocks of an odd image to an even image. This technique is known as “block matching”. Of course, it is also possible to use other techniques such as, for example, the technique of motion estimation by meshing. Thus, a matching of certain pixels of the even source images with pixels of the odd image is carried out. In the particular case of an estimation by blocks, the value of the motion of the block can be assigned to each pixel and to each subpixel of the block of the odd image. As a variant, the weighted motion vector of the block and the weighted motion vectors of the adjacent blocks are assigned to each pixel of the block according to the technique known as OBMC (Overlapped Block Motion Compensation).

The motion-compensated temporal filtering module 100 performs a discrete wavelet decomposition of the compensated images in order to decompose the video image sequence into several frequency subbands, distributed over one or more resolution levels. The discrete wavelet decomposition is applied recursively to the low-frequency subbands of the temporal subbands until the desired decomposition level is reached. The decision module 12 of the motion-compensated temporal filtering video encoder 10 determines whether the desired decomposition level has or has not been reached.

The various frequency subbands obtained by the motion-compensated temporal filtering module 100 are transferred to the scalable stream generation module 13. The motion estimation module 11 transfers the motion estimations to the scalable stream generation module 13, which composes a scalable data stream 18 from the various frequency subbands and motion estimations.

FIG. 2 shows a block diagram of the motion-compensated temporal filtering module of the video encoder of FIG. 1 using the matching method according to the invention when Haar filters are used in the wavelet decomposition.

The motion-compensated temporal filtering module 100 performs a temporal filtering according to the technique known as “lifting”. This technique makes it possible to perform a simple, flexible and perfectly reversible filtering equivalent to a wavelet filtering.

The source even image x₂[m,n] is up sampled by the up sampling module 110 by carrying out for example a discrete wavelet transform or SDWT synthesis, or by bilinear, bicubic interpolation or by cardinal sine. In this way, the image denoted x₂[m,n] is transformed by the up sampling module 110 into an image x′₂[m′,n′] having for example a resolution of one quarter of a pixel.

For the part of the motion-compensated temporal filtering module 100 consisting of the modules 110 to 114, the source image is the even image x₂[m,n].

The motion-compensated temporal filtering module 100 also comprises an initial motion connection module 121. The initial motion connection module 121 forms an image x′₁[m″,n″] comprising at least four times more pixels than the image xl[m,n]. The image x′₁[m″,n″] is formed by interpolation of x₁[m,n] or by any other method, and there is associated with each pixel or subpixel of the image x′₁[m″,n″] for example the motion vector of the block estimated by the motion estimation module 11 comprising these pixels. For the part of the motion-compensated temporal filtering module 100 consisting of the modules 110 to 114, the destination image is the odd image x₁[m,n].

Here, pixel of the image x′₂[m′,n′] is understood to mean a pixel of the image x′₂[m′,n′] which has the same position as a pixel of the image x₂[m,n] . Subpixel of the image x′₂[m′,n′] is understood to mean a pixel of the image x′₂[m′,n′] which has been created by a DWT synthesis and/or an interpolation. Pixel of the image x′₁[m″,n″] is understood to mean a pixel of the image x′₁[m″,n″] which has the same position as a pixel of the image x₁[m,n]. Subpixel of the image x′₁[m″,n″] is understood to mean a pixel of the image x₁[m″,n″] which has been created by a DWT synthesis and/or an interpolation.

The motion-compensated temporal filtering module 100 comprises a motion field densification module 112. The motion field densification module 111 associates with each of the pixels and subpixels of the destination image x′₁[m″,n″] at least one pixel of the source image x′₂[m′,n′] on the basis of the connections established by the initial motion connection module 121.

Once all the associations have been made, the accumulation model 112 creates an accumulation image Xa′[m″,n″]. The value of each of the pixels and subpixels of the accumulation image Xa′[m″,n″] is equal to the sum of the values of the pixels and subpixels of the source image x′₂[m′,n′] associated with the corresponding pixel or subpixel in the destination image x′₁[m″,n″], this sum being divided by the number of pixels and subpixels of the source image x′₂[m′,n′] associated with the corresponding pixel or subpixel in the image x′₁[m″,n″]. This division makes it possible to avoid the appearance of artefacts, such as pre-echo and/or post-echo effects, when the image sequence is decoded.

In one variant embodiment of the invention, a weight denoted W_{connex} is attributed to each of the associations. The updating value for each pixel or subpixel of the image Xa′[m′,n′] will be calculated according to the formula:

$$Maj = ( {\sum }_{associations} {W}_{connex} * Valsrc ) / {W}_{connex}$$

in which Maj is the value of a pixel or subpixel of the image X′a[m″,n″] and Valsrc is the value of the pixel of the source image x₂′ [m′,n′] associated with the pixel or subpixel of the destination image x′₁[m″,n″].

The image Xa′[m″,n″] is then filtered and subsampled by the subsampling module 113 so that it has the same resolution as the image x₁[m,n]. The subsampled image Xa′[m″,n″] is then subtracted from the image x₁[m,n] by the subtracter 114 in order to form an image denoted H[m,n] comprising high-frequency components. The image H[m,n] is then transferred to the scalable data stream generation module 13 and to the synthesis module 130.

For the part of the motion-compensated temporal filtering module 100 consisting of the modules 130 to 134, the source image is the image H[m,n].

The source image H[m,n] is up sampled by the synthesis module 130 by performing, for example, an SDWT synthesis so as to generate an image H′[m′,n′]. The synthesis module 130 is identical to the synthesis module 110; it will not be described in any greater detail.

The motion-compensated temporal filtering module 100 also comprises a motion field densification module 131.

The motion field densification module 131 reverses the initial connections between x₁′[m″,n″] and x₂′[m″,n″] generated by the initial motion connection module in order to apply them between the source image H′[m′,n′] and the destination image x₂[m,n]. For the part of the motion-compensated temporal filtering module 100 consisting of the modules 130 to 134, the destination image is the image x₂[m,n] or the image x₂′[m″,n″].

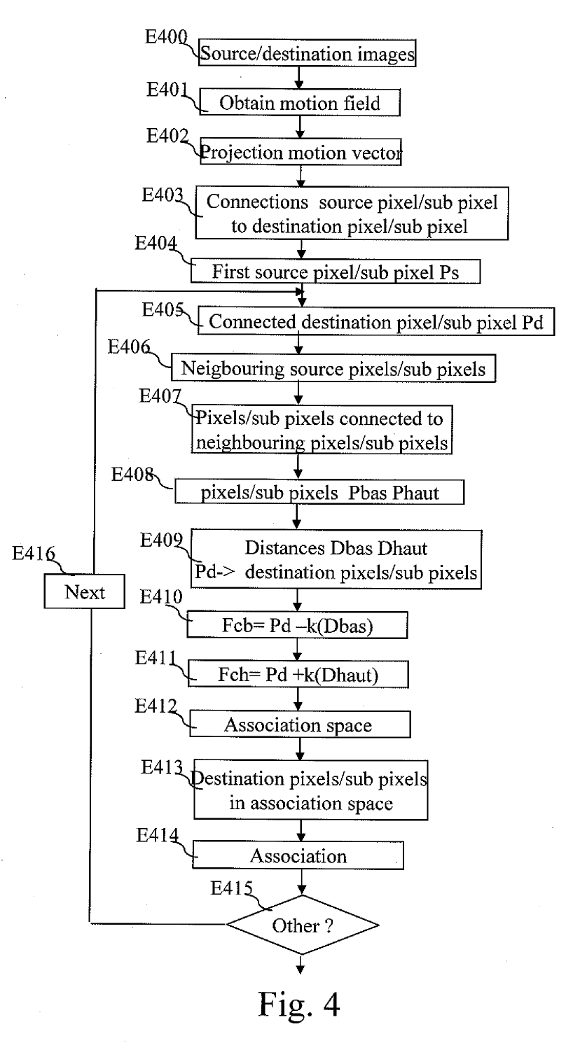

The motion field densification module 131 associates with each of the pixels and subpixels of the destination image x′₂[m″,n″] at least one pixel or subpixel of the source image H′[m′,n′] on the basis of the connections established by the initial motion connection module 121. This association will be described in more detail with reference to FIG. 4.

Once all the associations have been made, the accumulation module 133 creates an accumulation image Xb′[m″,n″]. The accumulation image Xb′[m″,n″] is of the same size as the destination image x₂′ [m″,n″] and the value of each of its pixels and subpixels is equal to the sum of the values of the pixels and subpixels of the source image H′[m′, n′] associated with the corresponding pixel or subpixel in the image x′₂[m″,n″], this sum being divided by the number of pixels and subpixels associated with the corresponding pixel or subpixel in the source image H′[m′,n′] . This division makes it possible to avoid the appearance of artefacts, such as pre-echo and/or post-echo effects, when the image sequence is decoded.

The image Xb′[m″,n″] is then filtered and subsampled by the subsampling module 133 so that it has the same resolution as the image x₂[m,n]. The sub sampled image Xb′[m″,n″] is then added for an half of to the image x₂[m,n] by the adder 134 so as to form an image denoted L[m,n] comprising low-frequency components. The image L[m,n] is then transferred to the decision module 12.

The image L[m,n] is then transferred from the decision module 12 of the motion-compensated temporal filtering video encoder 10 to the scalable data stream generation module 13 when the desired resolution level is obtained or is reprocessed by the motion-compensated temporal filtering module 100 for a new decomposition. When a new decomposition has to be carried out, the image L[m,n] is processed by the motion-compensated temporal filtering module 100 in the same way as that previously described.

Thus the motion-compensated temporal filtering module 100 forms, for example when Haar filters are used, high-frequency and low-frequency images of the form:

H[m,n]=x₁[m,n]−(W_{2->1}x₂[m,n]

L[m,n]=(x₂[m,n]+1/2(W_{1->2}H[m,n])

where W_{i→j} denotes the motion compensation of the image i on the image j.

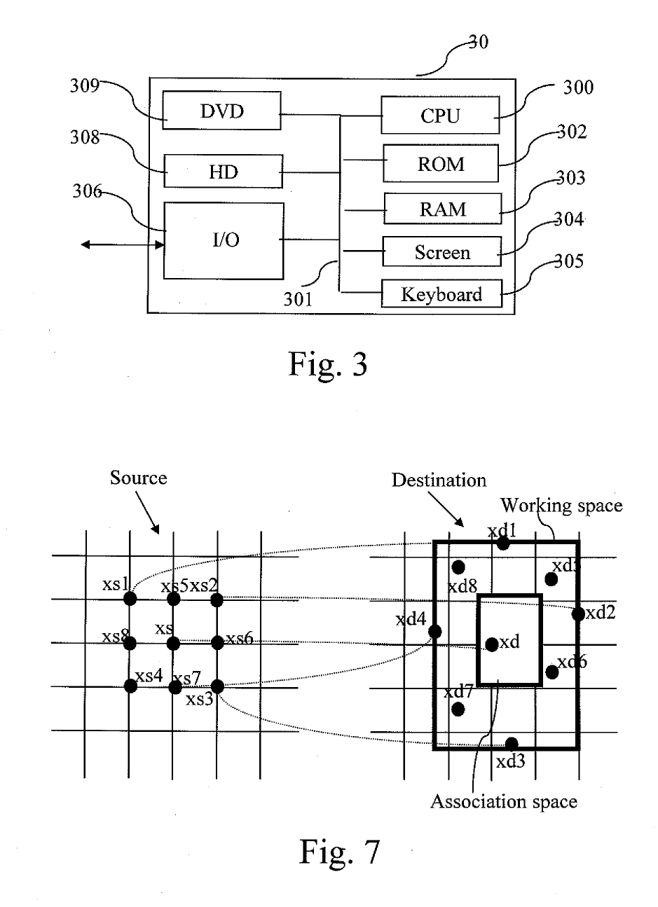

FIG. 3 shows a block diagram of a computer and/or telecommunication device which is able to execute the matching algorithm according to the invention.

This computer and/or telecommunication device 30 is able to perform, using software, a motion-compensated temporal filtering on an image sequence. The device 30 is also able to execute the matching algorithm according to the invention.

The device 30 is for example a microcomputer. It may also be integrated in a video image sequence display means such as a television or any other device which generates a set of information intended for receiving terminals such as televisions, mobile telephones, etc.

The device 30 comprises a communication bus 301, to which there are connected a central processing unit 300, a read only memory 302, a random access memory 303, a screen 304, a keyboard 305, a hard disk 308, a digital video disc or DVD player/recorder 309 and a communication interface 306 for communicating with a telecommunication network.

The hard disk 308 stores the program which implements the invention, as well as the data which allow the encoding and/or decoding according to the invention.

In more general terms, the programs according to the present invention are stored in a storage means. This storage means can be read by a computer or a microprocessor 300. This storage means may or may not be integrated in the device, and may be removable.

When the device 30 is powered up, the programs according to the present invention are transferred into the random access memory 303, which then contains the executable code of the invention as well as the data necessary for implementing the invention.

FIG. 4 shows the matching algorithm according to the invention executed by a processor of a computer and/or telecommunication device.

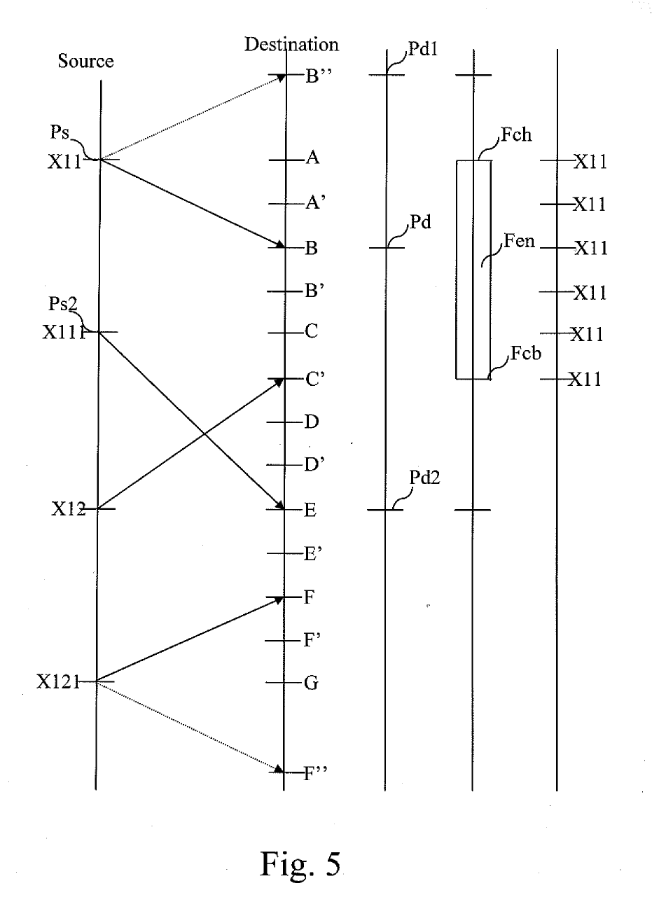

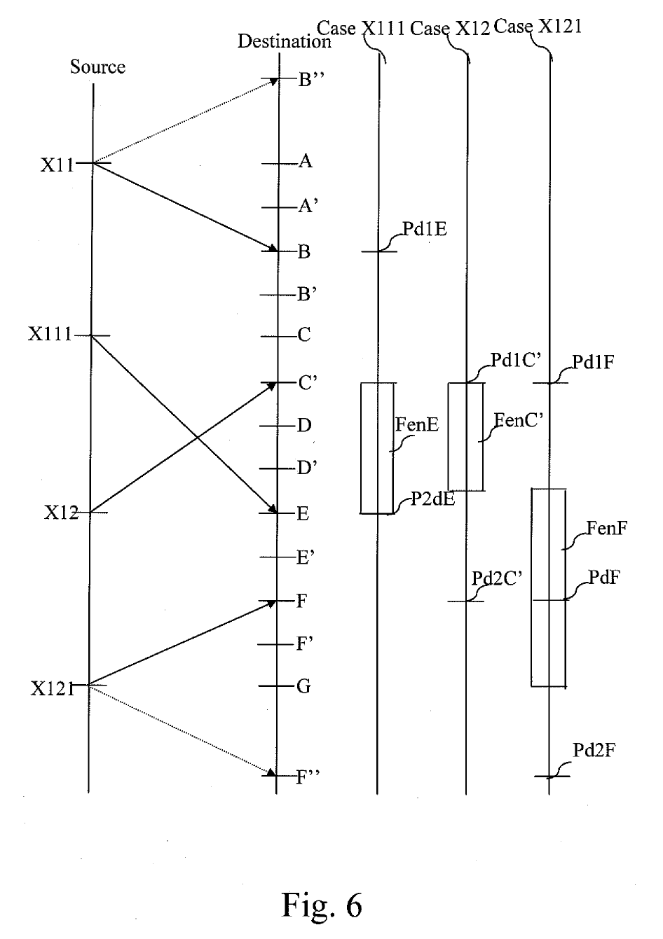

FIGS. 5 and 6 will be described in parallel with the present description of the algorithm of FIG. 4. In order to simplify the presentation, the present algorithm is described in the context of matching pixels and subpixels of a destination segment with pixels or subpixels of a source segment. Of course, the present algorithm is also applicable to the matching of pixels and subpixels of a destination image with pixels or subpixels of a source image.

In step E400, the source and destination images are obtained. Within the context of matching, these images are obtained by the motion-compensated temporal filtering module 100 of the video encoder of FIG. 1, the source image H′[m′,n′] and the destination image x′₂[m″,n″].

In the next step E401, the motion field between the source and destination images is obtained and a projection of this motion field is carried out in step E402 between the source image and the destination image. This projection is symbolised by the arrows between the source image and the destination image in FIGS. 5 and 6.

Step E403 constitutes the start of densification of the motion field, carried out for example by the densification module 131 of FIG. 2.

In this step, the pixels or subpixels of the destination image, on which the pixels or subpixels of the source image are projected by applying motion field vectors symbolised by the arrows in FIGS. 5 and 6, are connected to the pixels or subpixels of the source image. Thus, according to the example of FIGS. 5 and 6, the pixels or subpixels B, C′, E, F of the destination image are connected respectively to the pixels or subpixels X11, X12, X111 and X121 of the source image. It should be noted that the connections of the pixels or subpixels C′ and E are crossed. This is due to a flip movement in this part of the image. The pixels or subpixels B″ and F″ of the destination image are connected respectively to the pixels or subpixels X11 and X121 of the source image by carrying out conventional symmetry.

The pixels A, B, C, D, E, F and G in FIGS. 5 and 6 are pixels of the destination image. The pixels A′, B′, C′, D′, E′ and F′ are subpixels of the destination image.

In step E404, the iteration on the pixels and/or on the subpixels of the source image is initialised and the first pixel or subpixel of the source image is considered; this pixel or subpixel denoted Ps is the pixel X11 of the source image in FIG. 5.

In the next step E405, the pixel or subpixel of the destination image denoted Pd which is connected to the pixel or subpixel Ps is determined. The pixel or subpixel Pd is pixel B in FIG. 5.

In the next step E406, the pixels or subpixels Ps1 and Ps2 adjacent to the pixel or subpixel Ps are determined. According to our example, the pixel or subpixel Ps, located at the edge of the segment, has just one neighbour which is the pixel Ps2 X111. In this case, the neighbouring pixel Ps1 is the pixel Ps.

In the next step E407, the pixels or subpixels of the destination image which are connected to the pixels Ps1 and Ps2 are determined. These are the pixel E and the subpixel B′ obtained by symmetry of the projection of the vector connecting X11 to a pixel or subpixel of the destination image. These pixels or subpixels are denoted Pd1 and Pd2.

In step E408, a bottom pixel or subpixel denoted Pbas and a top pixel or subpixel denoted Phaut are determined among the set consisting of the pixels Pd1, Pd and Pd2. In FIG. 5, the pixel Phaut is the subpixel B″ and the pixel Pbas is the pixel E. The part of the image between the pixel or subpixel Phaut and the pixel or subpixel Pbas is then considered as a working space.

In step E409, the distances in terms of number of pixels or subpixels separating the pixel or subpixel Pd and respectively the pixel or subpixel Pbas and Phaut are determined. The distance separating Phaut and Pd is denoted Dhaut, and the distance separating Pbas and Pd is denoted Dbas.

In the next step E410, the bottom boundary of an association space is defined on the basis of the working space determined in step E408. The bottom boundary denoted Fcb is equal to the position of the pixel or subpixel with the distance Dbas subtracted, weighted by a coefficient k.

In the next step E411, the top boundary of the association space is defined. The top boundary denoted Fch is equal to the position of the pixel or subpixel Pd with the distance Dhaut added, weighted by a coefficient k.

According to one preferred embodiment, the coefficient k is equal to the constant ½. In one variant embodiment, the coefficient k is equal to another positive constant.

During step E412, the association space denoted Fen in FIG. 5, delimited by the boundaries Fcb and Fch, is determined.

In the next step E413, the pixels and subpixels of the destination image which are contained in the association space Fen are determined. According to the example of FIG. 5, the pixels and subpixels A, A′, B, B′, C and C′ are contained in the association space Fen.

In the next step E414, there is associated with each pixel and subpixel contained in the association space the pixel or subpixel of the source image connected to the pixel or subpixel Pd. Thus, according to the example of FIG. 5, the pixels or subpixels A, A′, B, B′, C and C′ are associated with the pixel or subpixel X11.

Once the association has been made, it is verified in step E415 whether all the pixels and/or subpixels of the source image have been processed. If they have, the present algorithm ends. If they have not, the algorithm passes to the next step E416 which consists in taking the next pixel or subpixel of the source image. According to the example of FIG. 5, the next pixel or subpixel is the pixel or subpixel denoted X111.

The loop consisting of steps E405 to E415 is reiterated until all the pixels or subpixels of the source image have been processed.

Thus, as shown in FIG. 6, the pixel or subpixel Pd connected to X111 is the pixel E, and the pixels or subpixels adjacent to X111 are X11 and X12 respectively connected to B and C′. The pixel Pbas which is determined is the pixel Pd2E and the pixel or subpixel Phaut is the subpixel Pd1E, the distance Dbas is zero since E is both the pixel connected to X111 and the pixel Pbas, the distance Dhaut is equal to six subpixels. Thus, the association space FenE, in the case where k is equal to ½, is between the pixel E and three subpixels above E. The pixels and subpixels C′, D, D′ and E are then associated with the subpixel X111.

Concerning the pixel X12, the pixel Pd connected to X12 is the subpixel C′, and the pixels or subpixels adjacent to X12 are X111 and X121 respectively connected to E and F. The pixel Pbas which is determined is the pixel Pd2C′ and the pixel Phaut is the subpixel Pd1C′, the distance Dhaut is zero since C′ is both the subpixel connected to X12 and the subpixel Phaut, the distance Dbas is equal to five subpixels. Thus, the association space FenC′, in the case where k is equal to ½, is between the subpixel C′ and two and a half subpixels above C′. The pixels and subpixels C′, D and D′ are then associated with the pixel X12.

Concerning the pixel or subpixel X121, the last pixel or subpixel of the source image, the pixel Pd connected to X121 is the pixel F, and the pixel or subpixel adjacent to X121 is X12 connected to C′, the pixel F″ being obtained by symmetry of the motion vector connecting X121 to F. The pixel Pbas which is determined is the pixel Pd2E and the pixel Phaut is the pixel or subpixel Pd1F, the distance Dhaut is equal to five subpixels and the distance Dbas is equal to four subpixels. Thus, the association space FenF, in the case where k is equal to ½, is between the pixel G and two and a half subpixels above F. The pixels and subpixels E, E′, F, F′ and G are then associated with the pixel or subpixel X121.

Thus, all the pixels and subpixels of the destination image are associated with at least one pixel or subpixel of the source image. The motion field is thus made perfectly reversible, taking account of any part reversals of images.

FIG. 7 shows an example of matching pixels and subpixels of a destination image with pixels of a source image.

FIG. 7 shows an application of the algorithm of FIG. 4 in a two-dimensional case. The pixel xs of the source image is connected to a pixel xd of the destination image and neighbouring pixels or subpixels xs1, xs2, xs3, xs4, xs5, xs6, xs7 and xs8 are connected to pixels or subpixels xd1, xd2, xd3, xd4, xd5, xd6, xd7 and xd8. A working space is determined which comprises neighbouring points by taking the maxima and the minima of the abscissas and ordinates of the pixels or subpixels connected to the neighbours. An association space is also determined in a homothetic manner as described above in FIG. 4, the central point xs being the centre of the homothety. Finally, in the same way as described with reference to FIG. 4, all the pixels or subpixels contained in the association space are associated with the source pixel xs .

The present invention is presented in the context of using Haar filters. Other filters, such as the filters known by the term 5/3 filters or 9/7 filters, are also used in the present invention. These filters use a larger number of source images in order to predict a destination image.

Conventionally, the modules 110 to 114 of the motion-compensated temporal filtering module of the video encoder are modules for predicting a destination image, whereas the modules 130 to 134 of the motion-compensated temporal filtering module of the video encoder are modules for updating a destination image.

The encoding devices as described in the present invention form, for each pair consisting of a source image and the destination image, an accumulation image in accordance with what has been presented above. Each of these accumulation images is taken into account for the prediction and/or updating of the destination image.

The accumulation image thus formed is then added to or subtracted from the destination image, after optional weighting associated with the “lifting” filtering coefficients.

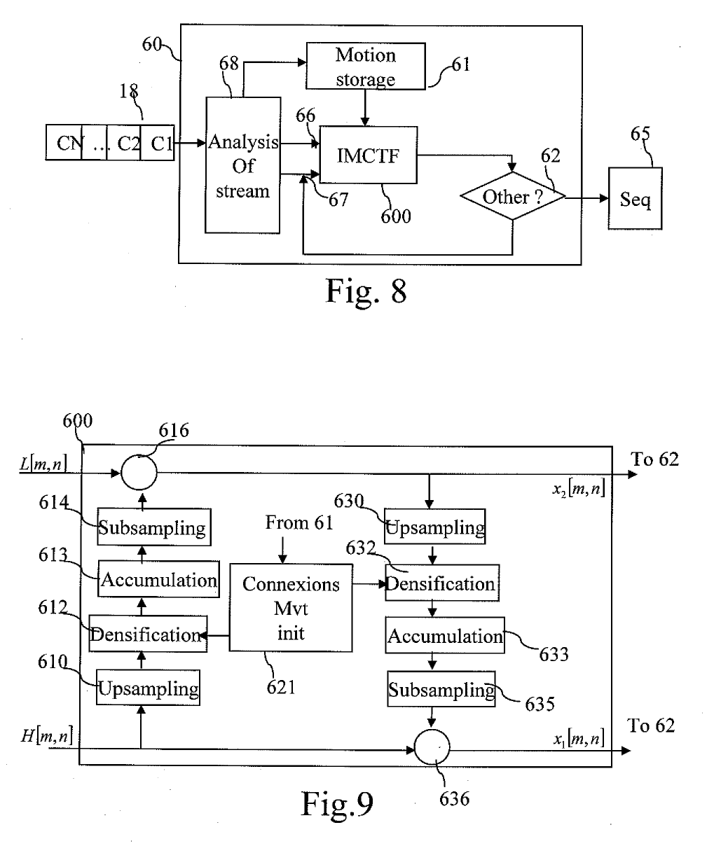

FIG. 8 shows a block diagram of a motion-compensated temporal filtering video decoder using the matching method according to the invention.

The motion-compensated temporal filtering video decoder 60 is able to decode a scalable data stream 18 into a video image sequence 65, the data contained in this scalable data stream having been encoded by an encoder as described in FIG. 1.

The motion-compensated temporal filtering video decoder 60 comprises an analysis module 68 for analysing the data stream 18. The analysis module 68 analyses the data stream 18 and extracts therefrom each high-frequency image of each decomposition level as well as the image comprising the low-frequency components of the lowest decomposition level. The analysis module 68 transfers the images comprising the high-frequency components 66 and low-frequency components 67 to the inverse motion-compensated temporal filtering module 600. The analysis module 68 also extracts from the data stream 18 the various estimations of the motion fields made by the encoder 10 of FIG. 1, and transfers them to the motion field storage module 61.

The inverse motion-compensated temporal filtering module 600 iteratively transforms the high-frequency image and the low-frequency image so as to form an even image and an odd image corresponding to the low-frequency image of higher decomposition level. The inverse motion-compensated temporal filtering module 600 forms a video image sequence from the motion estimations stored in the module 61 and from the high-frequency and low-frequency images. These motion estimations are estimations between each even image and the following odd image in the video image sequence encoded by the encoder 10 of the present invention.

The inverse motion-compensated temporal filtering module 600 performs a discrete wavelet synthesis of the images L[m,n] and H[m,n] so as to form a video image sequence. The discrete wavelet synthesis is applied recursively to the low-frequency images of the temporal subbands until the desired decomposition level is reached. The decision module 62 of the inverse motion-compensated temporal filtering video decoder 600 determines whether the desired decomposition level has or has not been reached.

FIG. 9 shows a block diagram of the motion-compensated inverse temporal filtering module of a video decoder of FIG. 8 using the matching method according to the invention when Haar filters are used in the wavelet decomposition.

The inverse motion-compensated temporal filtering module 600 performs a temporal filtering according to the “lifting” technique so as to reconstruct the various images of the sequence of video images encoded by the encoder of the present invention.

The image H[m,n] or source image is up sampled by the up sampling module 610 so as to form an image H′[m′,n′].

The motion-compensated temporal filtering module 100 also comprises an initial motion connection module 621 which is identical to the initial motion connection module 121 of FIG. 2; it will not be described in any further detail.

The inverse motion-compensated temporal filtering module 600 comprises an inverse motion field densification module 612. The inverse motion field densification module 612 is identical to the motion field densification module 132 of FIG. 2; it will not be described in any further detail.

The inverse motion-compensated temporal filtering module 600 comprises an accumulation module 613 which is identical to the accumulation module 133 of FIG. 2; it will not be described in any further detail. The accumulation module 613 creates an accumulation image Xb′[m″,n″].

The inverse motion-compensated temporal filtering module 600 comprises a subsampling module 614 which is identical to the subsampling module 133; it will not be described in any further detail.

The inverse motion-compensated temporal filtering module 600 comprises an adder 616 which subtracts half of the filtered and subsampled image Xb′[m″,n″] from the image L[m,n] in order to form an even image denoted x₂[m,n]. The image x₂[m,n] or source image is up sampled by the up sampling module 630 so as to form an image x′_{2′}[m′,n′]. The synthesis module 630 is identical to the up sampling module 610 of FIG. 9; it will not be described in any further detail.

The inverse motion-compensated temporal filtering module 600 comprises a motion field densification module 632. The motion field densification module 632 is identical to the motion field densification module 111 of FIG. 2; it will not be described in any further detail.

The inverse motion-compensated temporal filtering module 600 comprises an accumulation module 633 which is identical to the accumulation module 112 of FIG. 2; it will not be described in any further detail. The accumulation module 633 creates an accumulation image Xa′[m″,n″].

The inverse motion-compensated temporal filtering module 600 comprises a subsampling module 635 which is identical to the subsampling module 614; it will not be described in any further detail. The inverse motion-compensated temporal filtering module 600 comprises an adder 636 which adds the filtered and subsampled image Xa′[m″,n″] to the image H[m,n] in order to form an odd image denoted x₁[m,n]. This odd image is transferred to the decision module 62. The images x₁[m,n] and x₂[m,n] are, according to the desired decomposition level, interleaved so as to produce an image L[m,n] which may or may not be reintroduced with the image H[m,n] of the same level, read in the scalable data stream 18 in the inverse motion-compensated temporal filtering module 600.

The densification method and device according to the present invention find many applications in fields other than that described above.

For example, and in a non-limiting manner, the densification method and device can also be used within the context of video image sequence encoders such as MPEG 4 encoders and decoders or encoders which use a predictive mode by means of motion compensation. In these encoders, a bidirectional image is conventionally predicted from the preceding image of the video image sequence decoded in prediction or in intra mode. The use of the densification method or device within such a context makes it possible to provide in a simple manner direct and inverse motion fields between all the images of the video image sequence.

Another example of application of the densification method and device according to the present invention is the field of rendering within the context of a synthesis scheme objects represented in surface form, in which it is necessary to project onto an image plane or to render a polygon from a meshed surface. According to the present invention, such rendering is carried out by considering a rendering by voxels of variable size located at the nodes of polygons, a voxel being a sphere in a three-dimensional space representing a ball which helps to define a volume or a surface. According to the invention, the size of the voxels is defined by the size of the association space.

Of course, the present invention is in no way limited to the embodiments described here, but rather, on the contrary, encompasses any variant within the capability of the person skilled in the art.

1. Method of densifying a motion field between a destination image and a source image from a motion field between the source image and the destination image, the method comprising:
determining connections between pixels or subpixels of the source image and pixels or subpixels of the destination image,
determining, for each pixel or subpixel of the destination image connected to a pixel or subpixel of the source image, a pixel or subpixel association space including at least one pixel or subpixel of the destination image,
associating each pixel or subpixel in the association space with the pixel of the source image connected to said pixel or subpixel to form a dense motion field between the destination image and the source image.

2. Method according to claim 1, wherein the step of determining an association space includes:
determining a working space in the destination image as a function of pixels or subpixels connected to pixels or subpixels adjacent to the pixel or subpixel of the source image connected to the pixel or subpixel with which the working space is associated, and
determining the association space on the basis of the determined working space, on the basis of a pixel or subpixel with which the working space is associated and on the basis of the pixels or subpixels connected to the pixels or subpixels adjacent to the pixel or subpixel of the source image connected to the pixel or subpixel with which the working space is associated.

3. Method according to claim 2, wherein the step of determining the association space includes:
determining, among the pixel or subpixel with which the working space is associated and the pixels or subpixels connected to the pixels or subpixels adjacent to the pixel or subpixel of the source image connected to the pixel or subpixel with which the working space is associated, pixels or subpixels delimiting the working space as a function of their coordinates in the destination image, and
determining the association space on the basis of the coordinates of the pixel or subpixel with which the working space is associated and the distances separating the pixel or subpixel with which the working space is associated from the pixels or subpixels delimiting the working space.

4. Method according to claim 3, further including weighting by a coefficient of the order of one half the distances separating the pixel or subpixel with which the working space is associated from the pixels or subpixels delimiting the working space.

5. Device for densifying a motion field between a destination image and a source image from a motion field between the source image and the destination image, the device comprising a processor arrangement for:
determining connections between the pixels or subpixels of the source image and the pixels or subpixels of the destination image,
determining, for each pixel or subpixel of the destination image connected to a pixel or subpixel of the source image, a pixel or subpixel association space comprising at least one pixel or subpixel of the destination image, and
associating each pixel or subpixel in the association space with the pixel or subpixel of the source image connected to said pixel or subpixel to form a dense motion field between the destination image and the source image.

6. Device according t o claim 5, wherein the processor arrangement is arranged for determining an association space by operations including:
determining a working space in the destination image as a function of the pixels or subpixels connected to the pixels or subpixels adjacent to the pixel or subpixel of the source image connected to the pixel or subpixel with which the working space is associated,
determining the association space on the basis of the determined working space, on the basis of the pixel or subpixel with which the working space is associated and on the basis of the pixels or subpixels connected to the pixels or subpixels adjacent to the pixel or subpixel of the source image connected to the pixel or subpixel with which the working space is associated.

7. Device according to claim 6, wherein the processor arrangement is for determining the association space by operations including:
determining, among the pixel or subpixel with which the working space is associated and the pixels or subpixels connected to the pixels or subpixels adjacent to the pixel of the source image connected to the pixel or subpixel with which the working space is associated, pixels or subpixels delimiting the working space as a function of their coordinates in the destination image, and
determining the association space on the basis of the coordinates of the pixel or subpixel with which the working space is associated and the distances separating the pixel or subpixel with which the working space is associated from the pixels or subpixels delimiting the working space.

8. Device according to claim 7, wherein the distances separating the pixel or subpixel with which the working space is associated from the pixels or subpixels delimiting the working space are weighted by a coefficient of the order of one half.

9. Device for motion-compensated temporal filtering of a video image sequence encoder, comprising the device for densifying a motion field according to claim 5.

10. Device for motion-compensated temporal filtering of a video image sequence decoder, comprising the device for densifying a motion field according to claim 5.

11. Computer readable medium or storage device storing a computer program comprising instructions for causing a computer system to perform the method of claim 1.

12. Signal comprising a video image sequence encoded by motion-compensated temporal filtering by discrete wavelet decomposition, the signal comprising high-frequency images and low-frequency images, the low-frequency images being obtained by densifying a motion field between a source image from a group of source images and a destination image from a group of destination images on the basis of a motion field between the destination image and the source image, and in which the densification is performed by determining connections between the pixels or subpixels of the source image and the pixels or subpixels of the destination image, by determining, for each pixel or subpixel of the destination image connected to a pixel or subpixel of the source image, a pixel or subpixel association space comprising pixels and/or subpixels of the destination image, and by associating with each pixel or subpixel in the association space the pixel or subpixel of the source image connected to said pixel or subpixel to form a dense motion field between the destination image and the source image.

13. Method of transmitting a signal comprising a video image sequence encoded by motion-compensated temporal filtering by discrete wavelet decomposition, the signal comprising high-frequency images and low- frequency images, the low-frequency images being obtained by densifying a motion field between a source image from a group of source images and a destination image from a group of destination images on the basis of a motion field between the destination image and the source image, and in which the densification is performed by determining connections between the pixels or subpixels of the source image and the pixels or subpixels of the destination image, by determining, for each pixel or subpixel of the destination image connected to a pixel or subpixel of the source image, a pixel or subpixel association space comprising pixels and/or subpixels of the destination image, and by associating with each pixel or subpixel in the association space the pixel or subpixel of the source image connected to said pixel or subpixel to form a dense motion field between the destination image and the source image.

14. Method of storing a signal comprising a video image sequence encoded by motion-compensated temporal filtering by discrete wavelet decomposition, the signal comprising high-frequency images and low-frequency images, the low-frequency images being obtained by densifying a motion field between a source image from a group of source images and a destination image from a group of destination images on the basis of a motion field between the destination image and the source image, and in which the densification is performed by determining connections between the pixels or subpixels of the source image and the pixels or subpixels of the destination image, by determining, for each pixel or subpixel of the destination image connected to a pixel or subpixel of the source image, a pixel or subpixel association space comprising pixels and/or subpixels of the destination image, and by associating with each pixel or subpixel in the association space the pixel or subpixel of the source image connected to said pixel or subpixel to form a dense motion field between the destination image and the source image.

15. Device for encoding a video image sequence, comprising the motion-compensated temporal filtering device according to claim 9.

16. Device for decoding a video image sequence comprising the motion-compensated temporal filtering device according to claim 10.
